(19) United States
(12) Patent Application Publication
(10) Pub. No.: US 2003/0069810 A1
(43) Pub. Date: Apr. 10, 2003

(54) System and method for selling goods to customers of a public facility

(75) Inventors: Laurie E. Gathman, East Norwich, NY (US); Jack E. Haken, Danbury, CT (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/971,143

(22) Filed: Oct. 4, 2001

(51) Int. Cl. G06F 17/60

(52) U.S. Cl. 705/27

(57) ABSTRACT

A system and method for selling goods to customers attending events at a public facility. Customers gain access to the facility using electronic tickets stored on virtual ticket devices. Access terminals provide the virtual ticket devices with a way to communicate with the electronic ticket control system of the public facility to, among other things, gain access to the public facility using their electronic tickets. When the electronic ticket control system detects that a virtual ticket device is in the public-facility area, it causes a message relating to a possible sale of goods to be generated and transmitted to the virtual ticket device. When a customer affirmatively responds, the sale is concluded and the goods are delivered. A record of the transaction may be kept on the electronic ticket control system database for reference when generating future sales-related messages.

### CROSS-REFERENCE TO RELATED APPLICATIONS

The present invention is related to those disclosed in the following United States Patent Applications:

1. Serial No. [Docket No. US 010493], filed concurrently herewith, entitled “SELLING BEST AVAILABLE SEATS AT A PUBLIC FACILITY”;

2. Serial No. [Docket No. US 010494], filed concurrently herewith, entitled “SYSTEM FOR DISPLAYING PERSONAL MESSAGES AT A PUBLIC FACILITY AND METHOD OF DOING BUSINESS”;

3. Serial No. [Docket No. US 010495], filed concurrently herewith, entitled “SYSTEM AND BUSINESS FOR OFFERING SEAT UPGRADES TO PATRONS AT A PUBLIC FACILITY”;

4. Serial No. [Docket No. US 010496), filed concurrently herewith, entitled “BUSINESS METHOD AND SYSTEM FOR COMMUNICATING PUBLIC-FACILITY STATUS INFORMATION THROUGH A VIRTUAL TICKET DEVICE”;

5. Serial No. [Docket No. US 010497], filed concurrently herewith, entitled “TICKET EXCHANGE SYSTEM AND METHOD OF OPERATION”;

6. Serial No. [Docket No. US 010498], filed concurrently herewith, entitled “PUBLIC-VENUE AUCTION SYSTEM AND METHOD OF OPERATION”, and

7. Serial No. [Docket No. US 010500], filed concurrently herewith, entitled “SYSTEM AND METHOD FOR SELLING IMAGE DISPLAY TIME TO CUSTOMERS OF A PUBLIC FACILITY”.

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed to electronic ticket control systems and, more specifically, to a system and method for selling goods to public-facility patrons using a virtual ticket device.

### BACKGROUND OF THE INVENTION

Large public entertainment facilities, such as convention centers, concert halls, stadiums, sports arenas, and the like, are the civic centers of many communities and are important sources of revenue and employment. Quite often, public facilities are funded by taxpayers in order to attract or at least retain sports franchises, and to attract tourists and conventions. The large sums invested in public entertainment facilities make it essential to maximize the revenue derived from such facilities and to minimize their operating costs.

However, large public facilities tend to be labor intensive operations. A typical sports facility requires a large number of gate attendants, ticket agents, ushers, concession stand operators, shop vendors, and security officers, and the like. Many new sports facilities also employ waiters and waitresses who take orders from, and serve food and drink to, customers at their seats. Facility operators use labor-saving technology wherever possible in order to offset the high labor costs associated with large public facilities.

In addition to cutting costs, facility operators also try to increase revenue in different ways. The principle sources of revenue are ticket sales, concession stands, and vendor shops. Promotions are frequently offered in order to increase sales and many public facilities do not permit patrons to bring their own food and drink into the venues. And facility operators are increasingly seeking new technology to provide new and attractive services to customers and thereby increase attendance and revenue.

There is therefore a need in the art for technical improvements that reduce the costs of operating large public entertainment facilities. In particular, there is a need for new technologies that help to reduce labor costs associated with a operating large public facilities. Additionally, there is a need for technical improvements that enhance the revenues of large public facilities. More particularly, there is a need for new technologies that provide useful and enjoyable services to the patrons of large public facilities.

### SUMMARY OF THE INVENTION

To address the above-discussed deficiencies of the prior art, it is a primary object of the present invention to provide a product sales method available through a public-facility virtual ticket device. A virtual ticket device is a portable computer system that delivers virtual tickets for sports events, theater, concerts, and the like, together with various services and methods of doing business which are linked to and implemented through the virtual ticket device.

In its simplest form, the virtual ticket device is an existing smart telephone or cellular communication-enabled personal digital assistant (PDA), such as a PALM PILOTS or a VISORS electronic organizer. A dedicated virtual ticket device could also be used. A customer who wishes to attend an event purchases admission in any conventional manner (e.g., by telephone from a ticket service, in person at a box office, via the Internet). The ticket vendor sends an encrypted admission authorization record over a wireless channel or a wireline channel to the virtual ticket device, where it is stored as a virtual electronic ticket.

It will be recognized that the virtual ticket device serves multiple functions to its user. There are clear synergies between many of these functions; for example the communications functions of the device may be enhanced when the customer's seat location and entry time are known and stored in the system. Nevertheless many aspects of the present invention remain new and useful even when the customer is admitted to the facility with a paper ticket or in another conventional manner and for this reason, the term “virtual ticket device” as used in this patent specification and the claims which follow, is not limited or restricted to a device which is actually used or even programmed to authorize a customer's admission to the facility.

The encrypted admission authorization record may include, for example, information which identifies the date and location of the event, the seat number, price paid, and the like. The encrypted admission authorization record also may include uniquely encrypted information which may be used in a conventional manner to authenticate that the record is genuine. The same information is preferably stored in a central database which is accessible by the event operator and/or his service provider. The record in the database should preferably also include the telephone number or wireless address of the virtual ticket device so that contact with the virtual ticket device may be established at a later time.

Entry point terminals are provided at the entrances of the public entertainment facility which read at least the encrypted authentication information from the virtual ticket device and authorize the customer to enter the event. The entry point terminals read the authentication information over a very short range wireless (RF) channel or infrared (IR) channel, or via a dedicated interface slot coupled to a wireline channel to prevent eavesdropping and spoofing of the process. For example, the virtual ticket device may be programmed to display the data either as a string of characters (e.g., serial number) or a bar code on its LCD display and the displayed information can be optically scanned in a chamber of the entry point terminal.

Further, according to an advantageous embodiment of the present invention, the virtual ticket device comprises: 1) a memory capable of storing a virtual ticket operable to gain admission to a public facility; and 2) a communication controller capable of establishing a communication link to a terminal device associated with the public facility and transmitting the virtual ticket to the terminal device for authentication. The communication link is used to promote, negotiate, and consummate sales of goods by the public facility to patrons.

Once the customer has purchased a virtual ticket, the virtual ticket device can be used, in conjunction with information stored in the database to provide a number of distinct information and marketing services to the customer. In one embodiment, the present invention includes a database for storing customer-profile information, including, if known, their location within the public facility. The invention further includes a matching algorithm for determining which of a plurality of sales or other promotional opportunities would most advantageously be presented to a particular patron or patrons. Also included is a message generator for generating and transmitting a notification message to the selected virtual ticket devices.

Preferably both the virtual ticket device and the arena or theater is also equipped with hardware and software which can track the location of the virtual ticket device in and around the entertainment facility with a precision of perhaps a few meters.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. In particular, a controller may comprise a data processor and an associated memory that stores instructions that may be executed by the data processor. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a plan diagram of an entertainment venue in which an electronic ticket control system according to the principles of the present invention may be deployed;

FIG. 2 illustrates a virtual ticket device which is capable of interacting with an electronic ticket control system according to the principles of the present invention;

FIG. 3 illustrates a virtual electronic ticket displayed on the virtual ticket device in FIG. 2 according to one embodiment of the present invention;

FIG. 4 illustrates an electronic ticket control system according to one embodiment of the present invention;

FIG. 5 is a flow diagram illustrating the operation of the electronic ticket control system and the virtual ticket device according to one embodiment of the present invention;

FIG. 6 illustrates selected portions of electronic ticket control system that are utilized in the sales of goods to patrons of exemplary public facility according to one embodiment of the present invention; and

FIG. 7 is a flow diagram illustrating a method of selling goods to customers of a public facility according to an embodiment of the present invention.

### DETAILED DESCRIPTION OF THE INVENTION

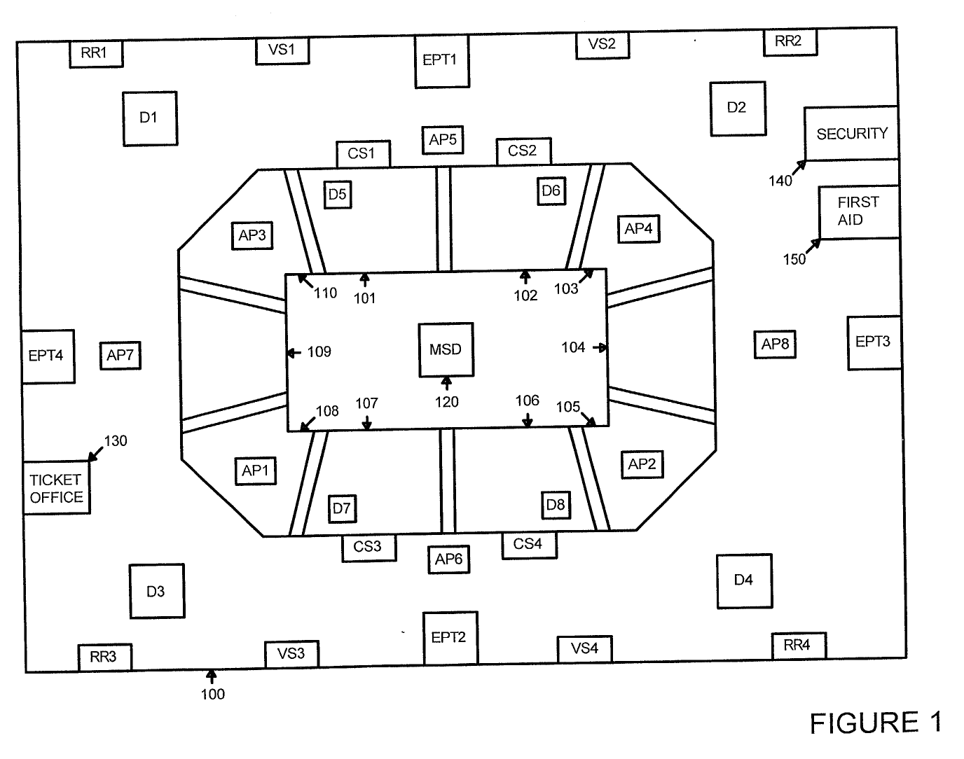

FIGS. 1 through 7, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged hand-held electronic organizer, personal digital assistant, or advanced mobile telephone.

FIG. 1 is a plan view of public facility 100 in which an electronic ticket control system according to the principles of the present invention may be deployed. Public facility 100 is representative of any public venue that is capable of holding a large audience. Thus, public facility 100 may include a football or baseball stadium, a basketball or hockey arena, a large concert hall, a convention center, and the like. As used herein and for the purpose of determining the scope of the claims of the present invention, the term “public facility” may include any controlled-access location to which people may be admitted by means of an electronic ticket control system and should not be construed to exclude facilities that are privately owned or that are open only to selected portions of the general public. In fact, public facility 100 may include controlled-access private clubs and private buildings, and even controlled-access forms of transportation, such as trains, planes, cruise ships, and the like. However, for the purpose of simplicity in explaining the principles of the present invention, it shall be assumed that public facility 100 is a sports facility.

Public facility 100 comprises a plurality of seating areas, including exemplary seat sections 101-110, that surround a playing area (e.g, hockey rink, basketball court, indoor track, or the like). Suspended over the playing area is multi-sided display (MSD) 120, which has large display screens on four sides. The seating areas are surrounded by an exterior promenade area that contains a plurality of concession stands (CS), including four exemplary concession stands labeled CS1, CS2, CS3 and CS4. The promenade area also includes a number of rest rooms (RR), including exemplary rest rooms labeled RR1, RR2, RR3 and RR4, and numerous vendor shops (VS), including exemplary vendor shops labeled VS1, VS2, VS3 and VS4. Finally, the promenade area contains ticket office 130, security office 140, and first aid station 150.

Electronic displays of various types are positioned throughout public facility 100. In the promenade area, displays D1, D2, D3 and D4 enable patrons at the concession stands or vendor shops, or waiting in rest room lines, to view the sporting event that is ongoing in the playing area. In the seating area, patrons can view displays D5, D6, D7 and D8, which typically display advertisements, scores of other sporting events, player statistics, audience greetings, and the like. As used herein and for the purpose of determining the scope of the claims of the present invention, displays D1-D8 may be any type of conventional display devices, including electronic signs, conventional sized television sets, large screen television sets, and multisided television displays, that generally may be viewed by at least some of the customers of public facility 100 and do not include non-public displays which are viewed by employees of public facility 100.

For example, each one of displays D1, D2, D3 and D4 may be an elevated multisided display system having three or four sides, wherein each side contains a large screen video display. Also, in an exemplary embodiment, one or more of displays D5-D8 in the seating area may be a conventional television set that is disposed in a luxury box of public facility 100.

Each of entry point terminals EPT1, EPT2, EPT3 and EPT4 is disposed next to one of four entrances to public facility 100. EPT1, EPT2, EPT3 and EPT4 are capable of detecting and registering the virtual electronic tickets used by customers of public facility 100. EPT1-EPT4 read at least the encrypted authentication information from the virtual ticket device and authorize the customer to enter public facility 100. Each one of EPT1, EPT2, EPT3 and EPT4 registers the admission of each virtual electronic ticket by any one of several conventional technologies. For example, one or more of EPT1, EPT2, EPT3 and EPT4 may comprise an optical scanner that scans a bar code or a serial number displayed on the display of a virtual ticket device that stores each virtual electronic ticket. Alternatively, one or more of EPT1, EPT2, EPT3 and EPT4 may comprise a radio frequency transceiver that establishes an RF link (such as a Bluetooth connection), or an infrared (IR) transceiver that establishes an IR link, that transfers the virtual electronic ticket information from the virtual ticket device used by the customer to the entry point terminal. In still another embodiment, one or more of EPT1, EPT2, EPT3 and EPT4 may contain a slot or a similar hardware interface into which a virtual ticket device may be inserted or engaged in order to transfer the virtual electronic ticket information via a wireline connection.

Additionally, a number of wireless or wireline access points (APs) are distributed throughout the seating area and the promenade area of public facility 100. Exemplary access points labeled AP1-AP8 are shown in FIG. 1. According to an advantageous embodiment of the present invention, EPT1-EPT4 may function both as access points and as entry point terminals. AP1-AP8 provide communication channels that permit the virtual ticket devices used by customers to communicate with the electronic ticket control system associated with public facility 100. According to an advantageous embodiment of the present invention, AP1-AP8 are radio frequency transceivers similar to the base stations of a cellular telephone system that provide two-way radio frequency (RF) communication links with virtual ticket devices within public facility 100. Preferably, AP1-AP8 have a hand-off capability that allows a customer to roam throughout public facility 100 without losing communication with the electronic ticket control system. Advantageously, this allows the electronic ticket control system to continually track the location of each virtual ticket device in public facility 100.

However, in alternate embodiment of the present invention, one or more of AP1-AP8 may be physical interface slots into which virtual tickets devices may be inserted. For example, each seat in public facility 100 may be provided with an interface slot (similar to an electronic cradle) that may mate with a virtual ticket device. A wireline connection to each such interface slot enables each virtual ticket device to communicate with the electronic ticket control system. Furthermore, according to an advantageous embodiment of the present invention, exterior access points may be disposed in the areas outside of public facility 100 in order to communicate with customers as they are nearing, and before they enter public facility 100.

Access points, such as AP1-AP8 and EPT1-EPT4, may be used to provide a variety of user-friendly services to the patrons of public facility 100. When a customer is near, but not yet admitted to, public facility 100, the access points may transmit useful information to the virtual ticket device used by the customer, including directions to the nearest entrance, advice as to which entrance has the shortest waiting line, promotional items available at vendor shops and concession stands, and the like. After the customer has been admitted to public facility 100, the access points may provide the virtual ticket device real time directions from her present location to her assigned seat, to particular concession stands or vendor shops, to rest rooms, or to other service areas. Information on which concession and service has the shortest line can also be provided.

Using the access points, the facility operator can know in real time how many admitted customers are at their seats and may schedule the start of programs on this basis. The public facility operator can utilize the communications link between the public facility electronic ticket control system and the virtual ticket devices to send messages, targeted or broadcast, to patrons to encourage them to patronize facility vendors, offer information about promotions, and even to consummate sales and arrange for payment. The patron can place orders for food and promotional items via the access points using the virtual ticket device and the vendors can deliver these goods to her present location. The access points and the virtual ticket device can also be used to authenticate the identity of customers before goods are delivered to them.

The facility operator may use the access points to communicate information to the virtual ticket devices about available seating upgrades. These could be based on the real time location of the customer. For example, an access point may transmit to the virtual ticket device the message: “Two seats are available in the section in front of you. Would you like to move there for an additional $10?” If the virtual ticket device has capability for broadband communication and a reasonably high quality display, this could be supplemented with video promotions, such as: “Here=s what the last home run looked like from section 110. Would you like to upgrade your seat and move there?”

Customers can use their virtual ticket devices to signal their present location within public facility 100 to friends and to locate lost family members. A network of entry point terminals may be used within public facility 100 to authorize admission to various areas such as preferred seating sections, clubs, luxury boxes, reserved rest rooms, priority parking lots, and the like. Additionally, automated cameras in public facility 100 may be used to photograph the customers during an event and the photographs can later be identified with groups of virtual tickets and offered for sale to the customers. In the case of accidents or disruptions, the location information can be used to contact potential witnesses. Additionally, seating and purchase information can be used for directed post-event marketing, which can be communicated directly to the virtual ticket device.

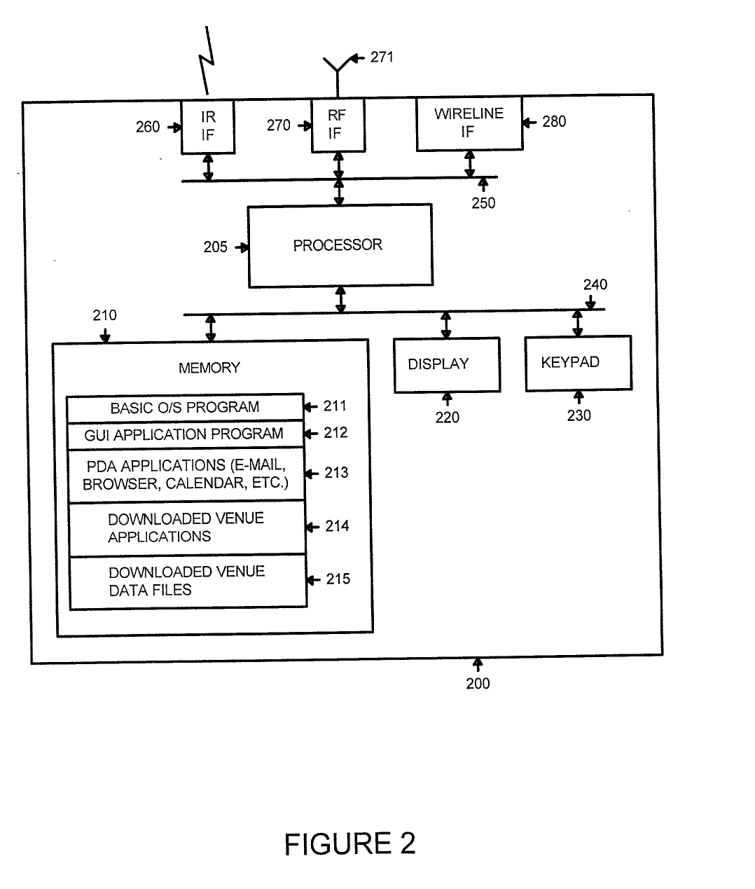

FIG. 2 illustrates virtual ticket device 200, which is capable of interacting with an electronic ticket control system according to the principles of the present invention. Virtual ticket device 200 comprises processor 205, memory 210, display 220, keypad 230, and one or more communication interfaces, including infrared (IR) interface (IF) 260, radio frequency (RF) interface (IF) 270, and wireline interface (IF) 280. Processor 205, memory 210, display 220, and keypad 230 are coupled to, and communicate via, system bus 240. Processor 205, memory 210, display 220, and keypad 230 are coupled to, and communicate via, input/output (I/O) bus 250.

Processor 205 controls the overall operation of virtual ticket device 200 by executing basic operating system (0/S) program 211 in memory 210. Memory 210 also stores graphical user interface (GUI) application program 212, a plurality of personal digital assistant (PDA) applications 213, downloaded venue applications 214, and downloaded venue data files 215. PDA applications 213 may include, for example, an e-mail application, a browser application, a calendar application, and the like.

In the illustrated embodiment, virtual ticket device 200 contains three external communication interfaces, namely, infrared interface 260, radio frequency interface 270, and wireline interface 280. However, not all of these external communication interfaces are necessary to the operation of the invention. For example, in an advantageous embodiment of the present invention, virtual ticket device 200 may only contain wireline interface 280 and RF interface 270. Virtual ticket device 200 may be adapted for insertion into a cradle device that plugs into wireline interface 280 and provides virtual ticket device 200 with electrical power for recharging a battery (not shown) in virtual ticket device 200. When virtual ticket device 200 is plugged into a cradle device, applications and data may be downloaded or uploaded via wireline interface 280.

For example, in an advantageous embodiment of the present invention, virtual ticket device 200 may be a wireless enabled electronic organizer, such as a Palm VIIθ organizer. As those skilled in the art are aware, a Palm VIIθ organizer (or an equivalent appliance) is capable of communicating via a wireless interface (such as RF interface 270) and may be mounted in a cradle device that provides wireline communication and power supply voltages to the organizer.

Processor 205 executes GUI application program 212 in order to interact with the operator of virtual ticket device 200 via keypad 230 and display 220. Normally, GUI application program 212 enables processor 205 to execute PDA applications 213 stored in memory 210. One of these applications may include a browser application that allows virtual ticket device 200 to access via RF interface 270 or wireline interface 280 a website for a ticket agency in order to purchase a virtual electronic ticket to an event at public facility 100. When a virtual electronic ticket is purchased in this manner, the virtual electronic ticket and other useful applications and data files may be downloaded from the ticket agency website to virtual ticket device 200 and stored in downloaded venue applications 214 and downloaded venue data file 215.

Downloaded venue data file 215 may be used to store such information as the virtual electronic ticket, electronic maps of public facility 100, text information related to concession stands and vendor shops, and text information related to security and first aid at public facility 100. Downloaded venue applications 214 may include one or more applications executed by processor 205 when the customer is at public facility 100. In particular, downloaded venue applications 214 may include a communication application that enables processor 205 to control the operation of RF interface 270 and wireline interface 280 such that virtual ticket device 200 is capable of communicating with access points AP1-AP8 and entry point terminals EPT1-EPT4 at public facility 100. For example, the communication application may configure RF interface 270 in virtual ticket device 200 to use the operating frequency channels and medium access control (MAC) layer protocols used by AP1-AP8 and EPT1-EPT4.

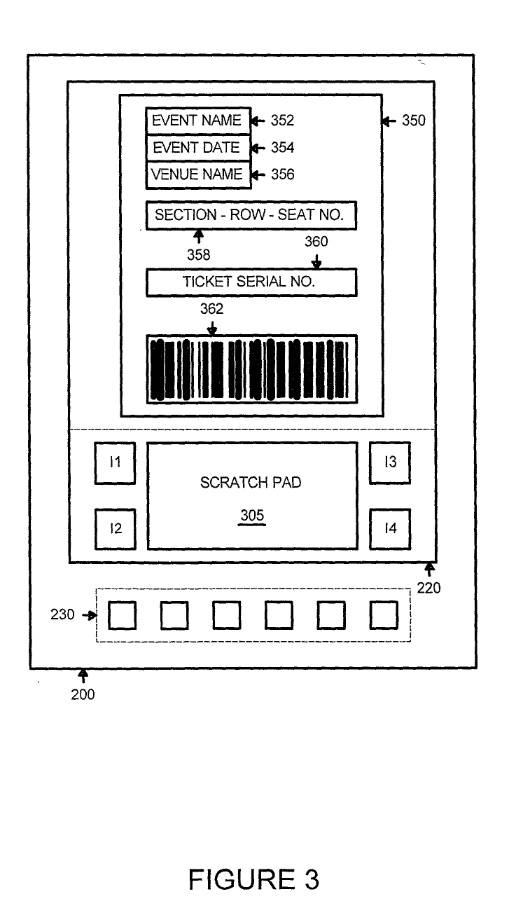

FIG. 3 illustrates virtual electronic ticket 350 displayed on virtual ticket device 200 according to one embodiment of the present invention. Virtual ticket device 200 comprises display 220, and keypad 230. The lower portion of display 220 contains scratch pad 305 and a plurality of icons, namely icons I1, I2, I3, and I4. The upper portion of display 220 contains virtual electronic ticket 350. Virtual electronic ticket 350 comprises event name field 352, event date field 354, venue name field 356, seating information field 358, ticket serial number field 360, and bar code field 362.

The operator of virtual ticket device 200 may use a stylus or a similar device to select icons I1, I2, I3 or I4 and thereby launch one or more of PDA applications 213 in memory 210. Additionally, the operator may use the stylus to enter text or numbers in scratch pad area 305 when executing one of PDA applications 213 that permits the entry of text data. Additionally, the buttons in keypad 230 may be used to select icons or to perform functions such as scroll up, scroll down, scroll left, scroll right and the like.

When the customer approaches or enters public facility 100, the customer turns on virtual ticket device 200 and launches the communication application in downloaded venue applications 214 that allows virtual ticket device 200 to communicate with entry point terminals EPT1-EPT4 and access points AP1-AP8 in public facility 100. The communication application may be launched automatically simply by selecting virtual electronic ticket 350 that has been downloaded and stored in downloaded venue data files 215. Event name field 352 contains the name of the event occurring in public facility 100, such as “New York Knicks vs. Indiana Pacers.” Event date field 354 contains the date on which the event is occurring, such as “Nov. 13, 2001.” Venue name field 356 contains the name of public facility 100, such as “Madison Square Garden”. Seating information field 358 contains the section, row and seat number information associated with virtual electronic ticket 350.

If the entry point terminal contain an optical scanner, the optical scanner may scan one or both of ticket serial number field 360 and bar code field 362. An optical character recognition application may be used to read the serial number appearing in ticket serial number field 360. A conventional bar code scanner device may read the bar code in bar code field 362. In either event, when virtual electronic ticket 350 is identified, the entry point terminal accesses the data base associated with the electronic ticket control system associated with public facility 100 and, if virtual electronic ticket 350 is properly authenticated, permits the customer to enter public facility 100. The entry point terminal may produce a visible or audible signal approving entry by the customer. Alternatively, if virtual electronic ticket 350 is not authenticated, the entry point terminal may generate an audible or visual alarm alerting a nearby gate attendant that the customer should not be admitted to public facility 100.

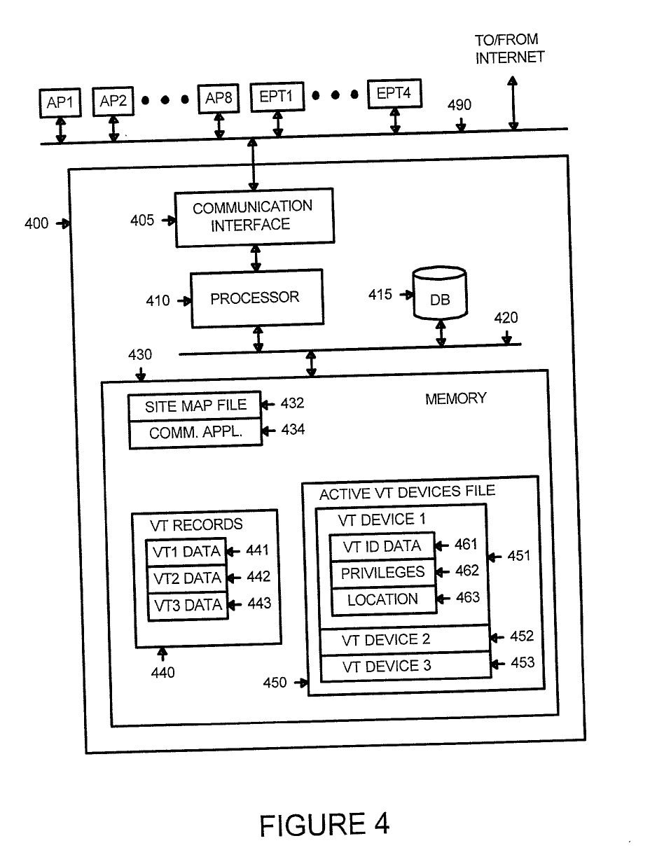

FIG. 4 illustrates electronic ticket control system 400 according to one embodiment of the present invention. Electronic ticket control system 400 comprises communication interface 405, processor 410, database (DB) 415, and memory 430. Processor 410, database (DB) 415, and memory 430 are coupled to, and communicate via system bus 420. Communication interface 405 has an external network connection that interfaces with network bus 490. Communication interface 405 enables processor 410 to communicate with exemplary access points AP1-AP8 and exemplary entry point terminals EPT1-EPT4. Communication interface 405 also enables processor 410 to communicate with remote servers and other devices via the Internet.

Memory 430 stores site map file 432, communication application program 434, virtual ticket records 440, and active virtual ticket devices file 450. Virtual ticket records 440 contains a plurality of virtual ticket data records 441-443, which are arbitrarily labeled VT1 DATA, VT2 DATA and VT3 DATA, respectively. Virtual ticket records 440 comprises a master list of all virtual tickets that were sold to the particular event occurring at public facility 100. Each virtual ticket data record 441-443 contains the serial number or bar code of each virtual ticket, the section and seat number information associated with each virtual ticket, payment information (optionally), the privileges associated with each virtual ticket, and the like. The virtual tickets that are received from the virtual ticket devices are compared to the virtual ticket data in virtual ticket records 440 before admitting each customer to public facility 100.

Virtual ticket data records 441-443 may be downloaded via the Internet from a server associated with a ticketing agency that sells tickets to events held at public facility 100. Alternatively, electronic ticket control system 400 itself also may function as a server that potential customers may access over the Internet in order to buy virtual tickets. As each virtual ticket is sold to a potential customer, electronic ticket control system 400 creates and stores a corresponding virtual ticket data record 441 and transmits the electronic virtual ticket over the Internet to the customer.

Active virtual ticket devices file 450 contains virtual ticket device records 451-453 associated with virtual ticket devices that are in active communication with electronic ticket control system 400. After each received virtual ticket is received and authenticated, a virtual ticket device record for the corresponding virtual ticket device that has been admitted is created in active virtual ticket device file 450. Virtual ticket device records 451453 are arbitrarily labeled VT DEVICE 1, VT DEVICE 2, and VT DEVICE 3, respectively. Exemplary virtual ticket device record 451 comprises virtual ticket (VT) identification (ID) data field 461, privileges field 462, and location field 463. Database 415 normally holds the master copies of all of the information stored in memory 430. However, the information in database 415 is loaded into memory 430 for processing by processor 410.

Site map file 432 contains electronic map data that may be downloaded to virtual ticket device 200 in order to display the location of the seat corresponding to a particular virtual ticket. The electronic map data also may illustrate the locations of the rest rooms, concession stands, vendor shops, ticket office 130, security office 140 and first aid station 150. Virtual ticket identification field 461 identifies the virtual ticket associated with virtual ticket device record 451. Privileges field 462 indicates the restricted areas in public facility 100 to which the virtual ticket gains admission. For example, privileges field 462 may indicate which restaurants and luxury boxes the user of a particular virtual ticket may enter. Finally, location field 463 indicates the current location of virtual ticket device 200.

Communication application program 434 comprises a communication protocol that may be transmitted to virtual ticket device 200 in order to permit virtual ticket device 200 to communicate with the access points and entry point terminals in public facility 100. According to one embodiment of the present invention, a user of virtual ticket device 200 may download communication application program 434 from electronic ticket control system 400 via the Internet before going to public facility 200. Alternatively, electronic ticket control system 400 may initially use a standard protocol to establish a simple connection with virtual ticket device 200 and then may download communication application 434 is order to establish a more advanced communication link.

For example, if EPT1 and virtual ticket device 200 are both Bluetooth-enabled systems, EPT1 may establish an initial Bluetooth connection with virtual ticket device 200 as the user of virtual ticket device 200 approaches EPT1. After the Bluetooth connection is established, EPT1 may download communication application program 434 to virtual ticket device 200. Thereafter, virtual ticket device 200 may use communication application program 434 to establish wireless LAN (e.g., IEEE 802.11) connections with one or more of EPT1-EPT4 and AP1-AP8 as the user of virtual ticket device 200 roams around public facility 100.

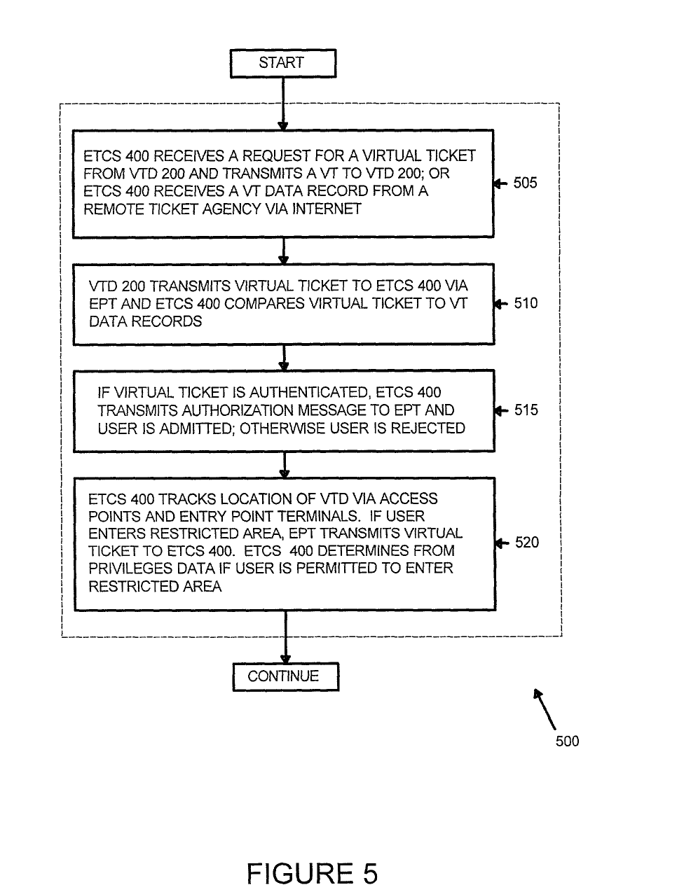

FIG. 5 depicts flow diagram 500, which illustrates the operation of electronic ticket control system 400 and portable virtual ticket device 200 according to one embodiment of the present invention. Initially, electronic ticket control system 400 receives a request for a virtual ticket from virtual ticket device 200. This request may be received via the Internet or via a telephone connection. In response, electronic ticket control system 400 transmits a virtual ticket to virtual ticket device 200. Alternatively, electronic ticket control system 400 may receive a virtual ticket data record for an already issued ticket from a remote ticket agency via the Internet (process step 505).

When the user finally arrives at public facility 100 to attend the event, virtual ticket device 200 transmits the virtual ticket stored in the virtual ticket device 200 to electronic ticket control system 400 via an entry point terminal. Electronic ticket control system 400 then compares the virtual ticket to the virtual ticket data records 440 stored in memory 430 or database 415 (process step 510). If the virtual ticket is authenticated, electronic ticket control system 400 transmits an authorization message to the entry point terminal and the user is admitted. Otherwise, the user is rejected (process step 515).

During the event, electronic ticket control system 400 may track the location of virtual ticket device 200 via the numerous access points and entry point terminals. If the user attempts to enter a restricted area, such as a private restaurant, a luxury box, or a premium seating area, the entry point terminal at the restricted area transmits the virtual ticket to electronic ticket control system 400. Electronic ticket control system 400 determines from the privileges data whether or not the user is permitted to enter the restricted area (process step 520).

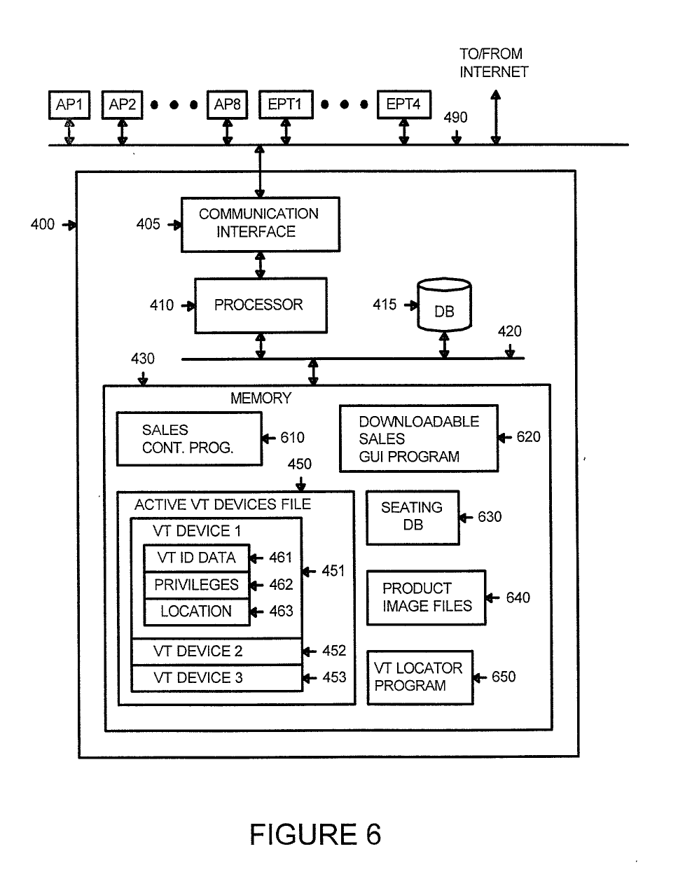

FIG. 6 illustrates selected portions of electronic ticket control system 400 that are utilized in the sales of goods to patrons of exemplary public facility 100 according to one embodiment of the present invention. In addition to the components illustrated and described above in FIG. 4, electronic ticket control system 400 also comprises a plurality of application programs and data files stored in memory 430 that enable electronic ticket control system 400 to communicate with virtual ticket devices in order to transmit sales-related offers and to receive responses. Memory 430 stores sales control program 610, downloadable sales graphical user interface (GUI) program 620, seating database (DB) 630, product-image files 640, and virtual ticket device locator program 650.

Processor 410 executes program instructions in sales control program 610 to enable electronic ticket control system 400 to communicate with virtual ticket devices in order to selectively offer products to and receive responses from the virtual ticket devices. It was noted in the above description of FIG. 2 that downloaded venue applications 214 in virtual ticket device 200 may include on or more applications executed by virtual ticket device 200 when the customer is at public facility 100. These applications may be downloaded before the customer arrives at public facility 100 (e.g., via the Internet) or may be downloaded at public facility 100 via entry point terminals EPT1-EPT4 or access points AP1-AP8. Downloadable sales program 620 is one such downloadable program. Sales GUI program 620 provides a graphical user interface in virtual ticket device 200 that enables the user to interact with sales control program 610.

According to an exemplary embodiment of the present invention, the graphical user interface of sales GUI program 620 may be similar to an e-mail application or to a two-way paging application. In an alternate embodiment of the present invention, the graphical user interface of sales GUI program 620 may be similar to a browser application in that sales offers and image views may be transmitted as HTML data and displayed in a web page format on virtual ticket device 200. Sales GUI program 620 displays one or more product selections to the user of virtual ticket device 200 and prompts the user to accept one of the upgrade seats or to refuse any upgrade offer. Product-image files 640 stores picture files (e.g., JPEG, BMP, GIF) associated with products in inventory.

Sales control program 610 uses virtual ticket device locator program 650 to determine the location of virtual ticket device 200. Generally, the location of virtual ticket device 200 may be determined from the section and seat information associated with the virtual ticket of the user. However, assuming the user roams around, the location of virtual ticket device 200 may be determined by transmitting a message to virtual ticket device 200 prompting the user to enter his or her current location (i.e., nearby section and seat values). In still another embodiment of the present invention, virtual ticket device 200 according to the location of the access point that is in communication with the virtual ticket device. In particular, in more advanced RF systems, virtual ticket device locator program 650 may use triangulation information captured by two or more access points to determine the location of virtual ticket device 200 without requiring any user input.

Seating database (DB) 630 is a master list of all seats in public facility 100. In order to execute a targeted-sales embodiment of the present invention, seating database 630 also maintains one or more indicators of the type of seat or simply the section a seat is in, which indicates a likely demographic profile of an occupant of the seat. For example, bleacher seats may have an above average number of young adults and young families; reserved seats, more professionals; and luxury boxes, large companies entertaining clients. This demographic information can help the facility operator to target product sales effectively.

Sales control program 610 may then generate and transmit to virtual ticket device 100 a product offer message related to one or more of products available at the facility which relates to an event at the facility such as T-shirts for a rock concert or baseballs for a baseball game. Advantageously, the product offer message may include at least one picture file showing a representative image of the product. The product offer message also may include a price associated with the product and any available incentive.

Example #1—Mike Piazza hits a homerun. The public facility instantly transmits a message to a plurality of virtual ticket devices 100 “Mike Piazza T-shirts for sale, $25.00.” The user can instantly accept the offer via the virtual ticket device 100.

Since many patrons are part of a group, in an advantageous embodiment of the present invention, sales control program 610 may offer the same product to a group of related seats. For example, virtual ticket device 200 may contain a plurality of virtual electronic tickets 350 that are used by a family or a group of friends that are sitting together. Alternatively, each member of a family or a group of friends may use individual virtual ticket devices 200 that each contain a virtual electronic ticket 350. Sales control program 610 may identify a group of related seats by identifying two or more virtual electronic tickets 350 that were paid for using the same credit card.

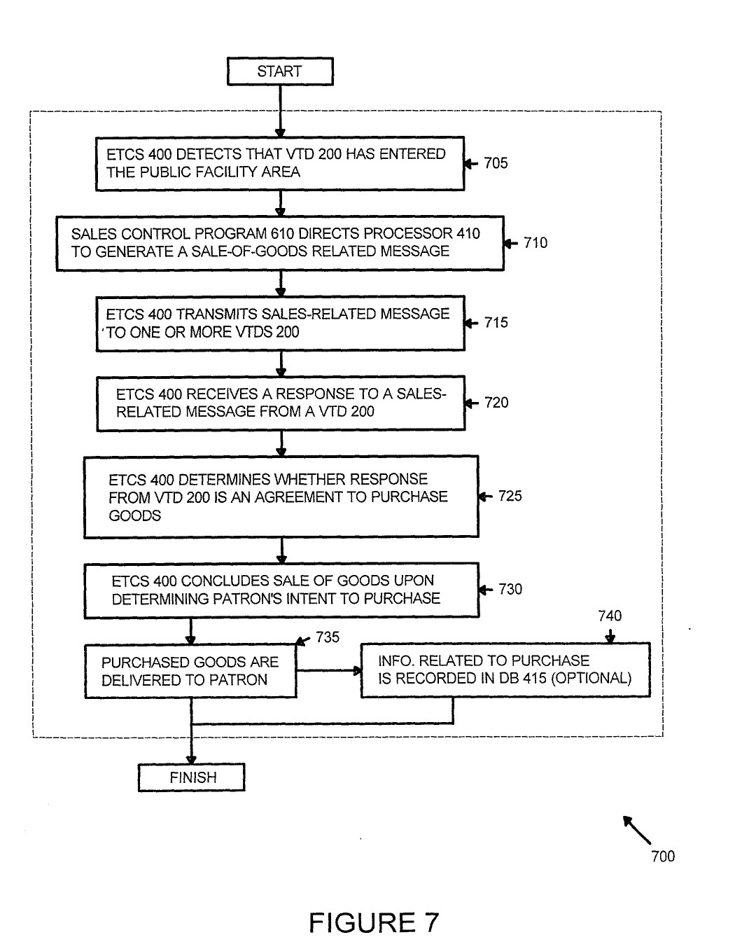

FIG. 7 is a flow diagram illustrating a method 700 of selling goods to customers of a public facility according to an embodiment of the present invention. Initially (process step START), the public facility has an electronic ticket control system 400 for issuing tickets to, and otherwise communicating with, virtual ticket devices 200. In addition to selling tickets for events, the public facility operates (or at least has a beneficial interest in) concession stands and other vendor outlets, which exist to sell goods to public facility patrons. Note that for convenience, “goods” will connote both the singular and the plural, referring either to a single item for sale or a group of items. A list of goods available for purchase at the public facility, or at least of a portion of them, is stored in a database in communication with the electronic ticket control system.

A process step 705, the electronic ticket control system (ETCS) 400 detects when a virtual ticket device VTD 200 has entered the vicinity of the public facility. The virtual ticket device may be detected, for example, when a user uses it to gain entry at a controlled-entry point, when the user initiates a communication with the electronic ticket control system for some other purpose, or simply when the user comes within range of a public facility access point. Note that the public-facility area or vicinity may extend beyond the physical walls enclosing the main facility.

At some point in time after the virtual ticket device has entered the public-facility area, which point in time may be, for example, randomly determined, manually determined, or based on the location of the virtual ticket device, sales control program 610 directs processor 410 to generate a message using the public facility goods information stored in the database (process step 710). The message may take the form of a purchase suggestion or advertisement including the availability or price of selected goods. The message is then transmitted to the virtual ticket device (process step 715). Note that the same transmission may be directed to only one VTD 200 or broadcast to any number of them. Upon entering the facility, for example, the user may be prompted to purchase a program, or told about a particular promotion for that day. If the user does not respond, the message may be retransmitted, either in its original or altered form. (Presumably, however, patrons will not respond to each message sent to them, and the system may simply wait until cued to send the next message.) When a user-response is received from a virtual ticket device (process step 720), the electronic ticket control system determines whether the response is a request for more information or an agreement to purchase the goods offered (process step 725). If it is a request for more information, the sales control program 610 directs processor 410 to generate and transmit an appropriate second message (step not shown). Upon determining a willingness to purchase, however, the electronic ticket proceeds to conclude the sale (process step 730). As used herein, “concluding the sale” is meant to broadly include confirmation of the purchase and arrangement for payment, as appropriate under the circumstances. Note, however, that no legal commitment to buy is inferred; the customer has simply indicated an express desire to purchase particular goods. And payment arrangements may range from credit card approval, trading on a public-facility account, if available, or simply specifying cash on delivery. After the sale is concluded, arrangements are made for delivery, and eventually the goods are delivered (process step 735). In one embodiment, the patron may simply go to a specified location to collect the goods. In an alternate embodiment, however, the purchased goods are delivered to the user's current location (that is, the virtual ticket device location). The delivery location may be the seat corresponding to the virtual ticket stored on the device, or some other location in the public-facility area either as reported by the patron or as determined by the virtual ticket device locator program of the electronic ticket control system. Note that “specific location” means a location determined with sufficient precision so as to make delivery possible.

In a particularly preferred embodiment, the electronic ticket control system targets specific public-facility goods messages to certain virtual ticket devices based on pre-determined selection criteria. (It may also, of course, simply broadcast messages to all virtual ticket devices for which it has an address, though the message will be received only by those within broadcast range.) These criteria may include historical information concerning past purchases made through a virtual ticket device, which is optionally stored to the database after delivery (process step 740). The criteria may also include the admission privilege associated with the virtual ticket stored on the virtual ticket device; for example, different messages may be sent to patrons in the upper deck and those in luxury boxes.

Although the present invention has been described in detail, those skilled in the art should understand that they can make various changes, substitutions and alterations herein without departing from the spirit and scope of the invention in its broadest form.

What is claimed is:

1. A method of doing business, comprising:
providing a public-facility electronic ticket control system for communicating with virtual ticket devices through public-facility access points, the virtual ticket devices for storing virtual tickets;
detecting when a virtual ticket device has entered the public-facility area; and
transmitting a message from the electronic ticket control system to the virtual ticket device, the message containing information relating to goods available for sale at the public facility which relate to an event at the public facility.

2. The method of doing business of claim 1, further comprising the step of receiving in the electronic ticket control system a responsive message relating to goods available for sale at the public facility.

3. The method of doing business of claim 2, further comprising the step of concluding a sale of goods a nd collecting the sale price of the goods.

4. The method of doing business of claim 3, further comprising the step of delivering the purchased goods to the virtual ticket device user.

5. The method of doing business of claim 4, wherein the delivery of goods is at a specific location in the public facility where the virtual ticket device is located at the time of delivery.

6. The method of doing business of claim 5, wherein the electronic ticket control system includes a virtual ticket device locator program that determines the specific location within the public facility where the goods should be delivered.

7. The method of doing business of claim 3, further comprising the step of storing information related to the concluded sale in a database.

8. The method of doing business of claim 7, wherein the content of the message containing information relating to goods available for sale is determined at least in part by information in the database relating to at least one previously concluded sale.

9. The method of doing business of claim 8, wherein the information in the database relates to at least one sale previously concluded through the virtual ticket device.

10. The method of doing business of claim 1, wherein the content of the message containing information relating to goods available for sale is determined at least in part by the admission privileges associated with an electronic ticket stored on the virtual ticket device.

11. The method of doing business of claim 1, wherein the electronic ticket control system includes a downloadable user-interface program.

12. The method of doing business of claim 1, further comprising the step of sending an image representing goods for sale at the public facility to the virtual ticket device.

13. A system for selling goods to virtual ticket device users in a public facility, comprising:
an electronic ticket control system;
at least one access point through which the electronic ticket control system may communicate with a virtual ticket device;
a sales database containing in formation relating to goods for sale at the public facility which relate to an event at the public facility;
a processor in communication with the sales database containing goods-related information for sending to a virtual ticket device through the at least one access point.

14. The system of claim 13, further comprising a sales control program for directing the processor to generate a goods-related message for transmission.

15. The system of claim 13 further comprising a virtual ticket device locator program for determining the specific location of a virtual ticket device in the public facility.

16. The system of claim 13, further comprising a downloadable user-interface program for downloading to a virtual ticket device and subsequent use in connection with the purchase of public-facility goods.

17. The system of claim 13, further comprising an image file database containing electronic image data relating to public facility goods for transmitting to a virtual ticket device.

18. A method of doing business, comprising:
providing a public-facility electronic ticket control system for communicating with virtual ticket devices through public-facility access points, the virtual ticket devices for storing virtual tickets;
detecting when a virtual ticket device has entered the public-facility area; and
transmitting a message from the electronic ticket control system to the virtual ticket device, the message containing information relating to goods available for sale at the public facility which relate to an event at the public facility, and wherein the step of transmitting a message transmits a message in response to an occurrence at the event and the goods offered for sale are specifically related to the occurrence.
